(19) United States
(12) Patent Application Publication
(10) Pub. No.: US 2016/0094276 A1
(43) Pub. Date: Mar. 31, 2016

(54) Transmitting and Receiving Packets

(71) Applicant: Alibaba Group Holding Limited, Grand Cayman (KY)

(72) Inventor: Xiaolin Shao, Hangshou (CN)

(21) Appl. No.: 14/866,483

(22) Filed: Sep. 25, 2015

(30) Foreign Application Priority Data
Sep. 29, 2014 (CN) 201410515665.6

(51) Int. Cl. H04B 5/00; G06K 7/14; H04W 76/02; H04L 29/06; H04W 4/00

(52) U.S. Cl. CPC H04B 5/0031; H04L 69/22; H04W 4/008; H04W 76/023; G06K 7/1417; G06K 7/1439

(57) ABSTRACT

Methods, devices, and systems for transmitting and/or receiving packets. A method for packet transmission may include generating a transmission packet corresponding to a packet associated with a first mobile terminal, and transmitting the transmission packet to a second mobile terminal using close data transmission techniques. A method for receiving packets may include receiving, by a computing device, the transmission packet from a first mobile terminal using close data transmission techniques. The computing device may parse the transmission packet to obtain the specific packet including local data and/or remote data, obtaining the remote data based on the remote data identifier, and displaying the local data and/or the remote data. The Implementations may solve problems including failure of duplicate a whole packet between mobile terminals and thereby enhance convenience and accuracy of information sharing between the mobile terminals.

### CROSS REFERENCE TO RELATED PATENT APPLICATIONS

This application claims priority to Chinese Patent Application No. 201410515665.6, filed on Sep. 29, 2014, entitled “Method and Apparatus of Transmitting/Receiving Data packet, Transmission System and mobile Device,” which is hereby incorporated by reference in its entirety.

### TECHNICAL FIELD

The present disclosure relates to mobile Internet technology, and more particularly to methods, devices, and systems for transmitting and/or receiving packets.

### BACKGROUND

With the continuous development of mobile Internet technology, information sharing between mobile terminals has become a universal demand. In some instances, certain information (e.g., a complete copy of an order) needs to be transmitted from one mobile terminal to another mobile terminal. For example, user A buys an item from Taobao and is satisfied with the item. User A may share the item to user B. Under current techniques, user A merely shares a single item to user B each time. However, when an order contains multiple items, multiple links to the multiple items have to be shared. Therefore, user B has to click each link and select a specific type of the item. User B then puts the item into the shopping cart and makes the payment. Upon completion of the above operations on a mobile device, these operations are complex and time consuming. Users may have a poor user experience.

In sum, the essence of sharing certain information between mobile terminals includes sharing of packets associated with a mobile terminal. When the certain packets are shared between the mobile terminals using current techniques, the mobile terminals can merely share specific sub-packets of the information. Thus, the current techniques fail to solve the technical problem related to replicating the entire data packet between mobile terminals.

### SUMMARY

Implementations herein relate to methods, systems, and devices for receiving and/or transmitting packets. The Implementations are useful for solving problems associated with current techniques. The problems include the inability to duplicate a whole packet between mobile terminals. This Summary is not intended to identify all key features or essential features of the claimed subject matter, nor is it intended to be used alone as an aid in determining the scope of the claimed subject matter.

The implementations relate to a method for packet transmission. The method may include generating a transmission packet corresponding to a packet associated with a first mobile terminal. The packet may include local data and/or remote data, and the transmission packet may include the local data and/or a remote data identifier capable of retrieving the remote data from the packet. The method may further include transmitting the transmission packet to a second mobile terminal using close data transmission techniques.

For instance, the packet may include an order packet. Data of the transmission packet may include at least one of an identifier of items related to an order, a title of the items, a specification of the items, or a number of the items.

For instance, the transmitting the transmission packet to a second mobile terminal using close data transmission techniques may include generating a matrix code (e.g., quick response (QR) code) of data of the transmission packet based on the transmission packet and obtaining the transmission packet in response to scanning of the QR code using an application of the second mobile terminal.

The implementations further relate to a device for packet transmission. The device may include a generating module configured to generate a transmission packet corresponding to a packet associated with a first mobile terminal, and a transmitting module configured to transmit the transmission packet to a second mobile terminal using close data transmission techniques. The packet may include local data and/or remote data, and the transmission packet may include the local data and/or a remote data identifier capable of retrieving the remote data from the packet. For instance, the packet includes an order packet. The data of the transmission packet may include at least one of an identifier of items related to an order, a title of the items, a specification of the items, or a number of the items.

In implementations, the transmitting module may include a generating submodule configured to generate a QR code of data of the transmission packet based on the transmission packet, and a scanning submodule configured to obtain the transmission packet in response to scanning of the QR code using an application of the second mobile terminal.

The implementations also relate to a method for receiving packets. The method may include receiving the transmission packet from a first mobile terminal using close data transmission techniques. The transmission packet may include the local data and/or a remote data identifier capable of retrieving the remote data from the packet. The method may further include parsing the transmission packet to obtain the packet including local data and/or remote data, obtaining the remote data based on the remote data identifier, and displaying the local data and/or the remote data. For instance, the receiving the transmission packet from the first mobile terminal using the close data transmission techniques may include obtaining the transmission packet in response to scanning of the QR code from a display of the first mobile terminal.

For instance, the parsing the transmission packet may include parsing the QR code. The obtaining the remote data based on the remote data identifier may include transmitting a reading request to a server transmitting the remote data based on the remote data identifier, and receiving the remote data from the server.

In implementations, the packet includes an order packet. In these instances, the method may further include generating a new order based on the order packet. For instance, the generating the new order based on the order packet may include receiving a request for the new order, obtaining an account and data of the order based on the new order, and generating and storing the new order based on the account and the data of the order.

The implementations relate to a device for receiving packets. The device may include a receiving module configured to receive the transmission packet from a first mobile terminal using close data transmission techniques. The transmission packet may include the local data and/or a remote data identifier capable of retrieving the remote data from the packet. The device may further include a parsing module configured to parse the transmission packet to obtain the packet including local data and/or remote data, and an acquiring module configured to obtain the remote data based on the remote data identifier. The device may further include a displaying module configured to display the local data and/or the remote data. For instance, the receiving the transmission packet from the first mobile terminal using the close data transmission techniques may include obtaining the transmission packet in response to scanning of the QR code from a display of the first mobile terminal. For instance, the parsing the transmission packet may include parsing the QR code.

In implementations, the acquisition module may include a requesting module configured to transmit a reading request to a server transmitting the remote data based on the remote data identifier, and a receiving submodule configured to receive the remote data from the server. For instance, the packet includes an order packet. The device may further include a generating module configured to generate a new order based on the order packet. In implementations, the generating module includes a receiving submodule configured to receive a request for the new order, an acquisition submodule configured to obtain an account and data of the order based on the new order, and a generating submodule configured to generate and store the new order based on the account and the data of the order.

The implementations further relate to a system for transmitting and receiving packets. The system may include a device for packet transmission as described above and a device for receiving packet as described above.

The implementations further relate to a mobile terminal. The mobile terminal may include a display, a processor, and memory. The processor may be configured to store a mobile shopping application. Upon implementing the mobile shopping application by the processor, the mobile terminal may display a pending order interface associated with a first user account in the display. The pending order interface may include a plurality of pending orders, and the plurality of pending orders are transferred in bulk from a mobile device associated with a second user account. The mobile device may operate transactions associated with the plurality of pending orders under the second user account before the plurality of pending orders are transferred in bulk.

Compared with the prior art, aspects of the present disclosure have the following advantages. The implementations relate to methods, systems, and devices for receiving and/or transmitting packets. The implementations may include generating a transmission packet corresponding to a packet associated with a first mobile terminal, transmitting the transmission packet to a second mobile terminal using close data transmission techniques, receiving the transmission packet from a first mobile terminal using close data transmission techniques, parsing the transmission packet to obtain the packet including local data and/or a remote data identifier, and obtaining the remote data based on the identifier of the remote data, and displaying data of a packet associated with the first mobile terminal on a display associated with the second mobile terminal. The implementations may solve problems under current techniques, and the problems include failure of duplicate a whole packet between mobile terminals. The implementations thereby enhance convenience and accuracy of information sharing between mobile terminals.

### BRIEF DESCRIPTION OF THE DRAWINGS

The Detailed Description is described with reference to the accompanying figures. The use of the same reference numbers in different figures indicates similar or identical items.

FIG. 1 is a flow chart of an illustrative process for packet transmission.

FIG. 2 is a flow chart of an illustrative process for the operation 3.04 described in FIG. 1.

FIG. 3 is a schematic diagram of an illustrative sharing interface for packet transmission associated with the first mobile terminal.

FIG. 4 is schematic diagrams of an illustrative computing device that enables packet transmission.

FIG. 5 is a flow chart of an illustrative process for receiving packets.

FIG. 6 is a schematic diagram of an illustrative sharing interface for receiving packet associated with the second mobile terminal.

FIG. 7 is another flow chart of an illustrative process for receiving packets.

FIG. 8 is a flow chart of an illustrative process for the operation 702 described in FIG. 7.

FIG. 9 is a schematic diagram of an illustrative computing device that enables receiving packets.

FIG. 10 is a schematic diagram of an illustrative computing system that enables packet transmission.

FIG. 11 is a schematic diagram of an illustrative mobile device.

### DETAILED DESCRIPTION

In the following description, numerous specific details are set forth in order to fully understand the present disclosure. However, the present disclosure may be implemented in many other ways than those described in the implementations. For example, those skilled in the art can make similar implementations without departing from the present disclosure. Therefore, the present disclosure is not limited to the particular implementations disclosed below.

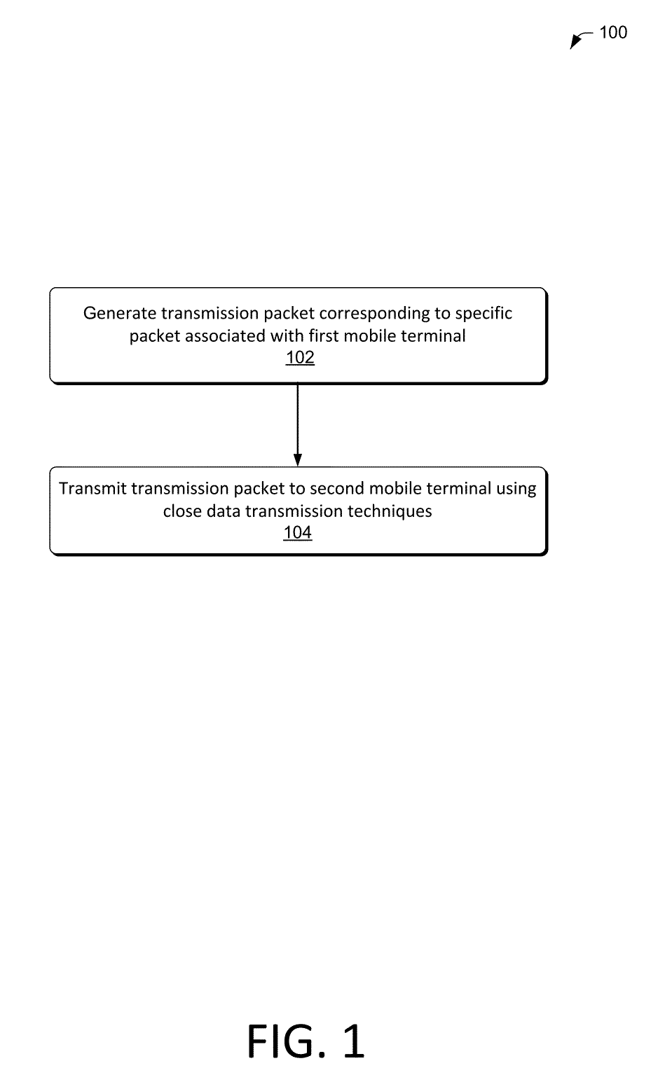

The implementations relate to a method for transmitting packets. FIG. 1 is a flow chart of an illustrative process for packet transmission.

At 102, a computing device (e.g., a mobile device) may generate a transmission packet corresponding to a specific packet associated with a first mobile terminal. The specific packet may include local data and/or remote data, and the transmission packet may include the local data and/or a remote data identifier capable of retrieving the remote data from the specific packet. The mobile terminal described herein includes, but is not limited to, mobile communications devices, for example a cell phone or smart phone, personal computer (PC), tablet (such as a PAD), wearable device and other devices. The method may be implemented in data packets transmission between the mobile communications device and other scenarios involving data packet transmission.

In implementations, the specific packet includes an order packet. The order packet may include local data and remote data related to the item of the specific order. For example, the transmission packet may include data of at least one of an identifier of items related to a specific order, a title of the items, a specification of the items, or a number of the items. In these instances, the identifier of the item related to the order may be used to obtain the remote data identifier of the remote data of the order packet. The local data of the order packet may include at least one of an identifier of items related to a specific order, a title of the items, a specification of the items, or a number of the items.

In implementations, a title of the items, a specification of the items, and/or a number of the items may be used as the local data of the specific order and/or the remote data of the specific order. The remote data identifier of the transmission packet may include an identifier of an item related to the specific order and/or an order number of the specific order.

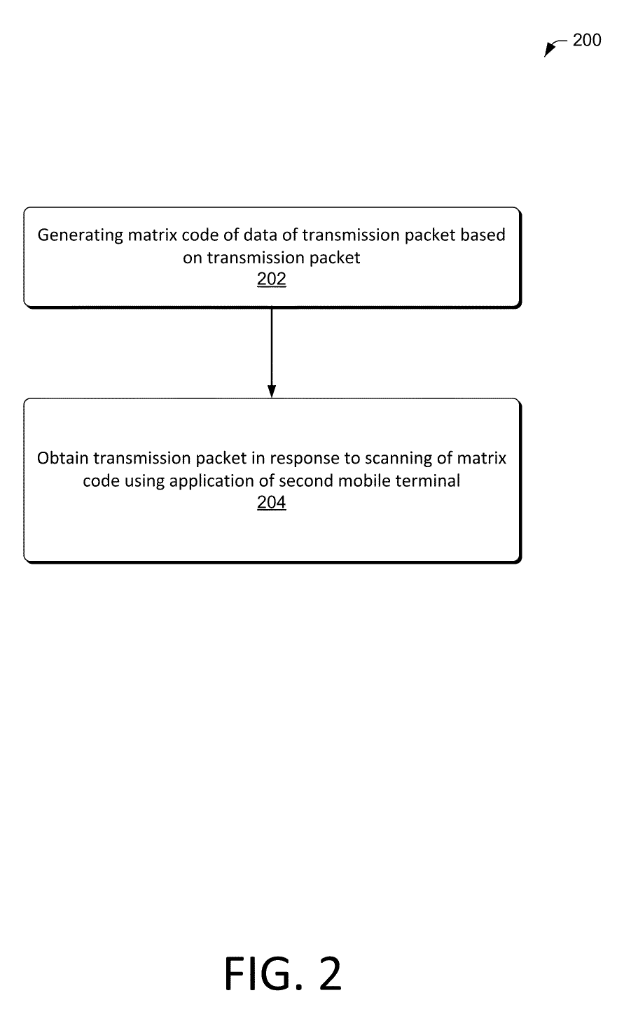

At 104, the computing device may transmit the transmission packet to a second mobile terminal using short-range or near-field data transmission techniques. FIG. 2 is a flow chart of an illustrative process for the operation 104 described in FIG. 1. The transmitting the transmission packet to a second mobile terminal using short-range or near-field data transmission techniques may include generating a quick response (QR) code of data of the transmission packet based on the transmission packet at 202. The QR code also referred to as two-dimensional code is one type of matrix code. The QR code may be generated based on a specific packet including all the local data.

In implementations, the QR code may be generated based on the remote data identifier of the remote data. In implementations, the QR code may be generated based on all the local data and the remote data identifier of the remote data. After the QR code is generated based at least on the remote data identifier of the remote data, the second mobile terminal may obtain remote data of the specific packet via a server that stores the remote data.

At 204, the second mobile terminal may obtain the transmission packet in response to scanning of the QR code using an application of the second mobile terminal. The implementations may use a short-range or near-field data transmission technique such as scanning QR codes. Other technique such as Bluetooth, NFC, and “shake” sharing may also be implemented. As used herein, “shake” sharing may be used as a mode for short-range or near-field data transmission. By shaking a phone or click a shaking button of the phone, the phone may be matched to another phone, which is also triggered by the same function substantially at the same time point. Therefore, users may share specific order packets in this manner. Various forms of the short-range or near-field data transmission techniques may be implemented.

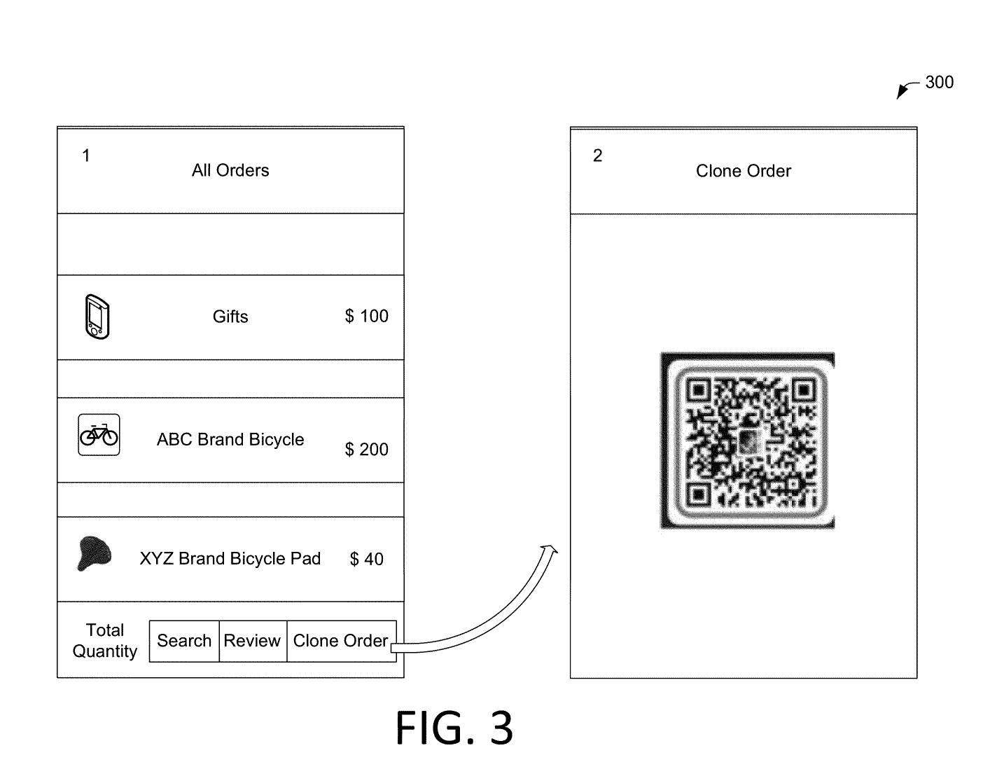

FIG. 3 is a schematic diagram of an illustrative sharing interface 300 for packet transmission associated with the first mobile terminal. In implementations, a first mobile terminal may copy an order using a client terminal of Taobao. The order may include various items and information of the items (e.g., quantities and specifications), which are displayed on a screen of the first mobile terminal. When the user selects “Clone Order”, the first mobile terminal may generate a QR code based on the information, and display the QR code on the screen of the first mobile terminal. The QR code is scannable for the second mobile terminal.

The implementations described above relate to a method for packet transmission. Corresponding to the method, the implementations further relate to a device for packet transmission.

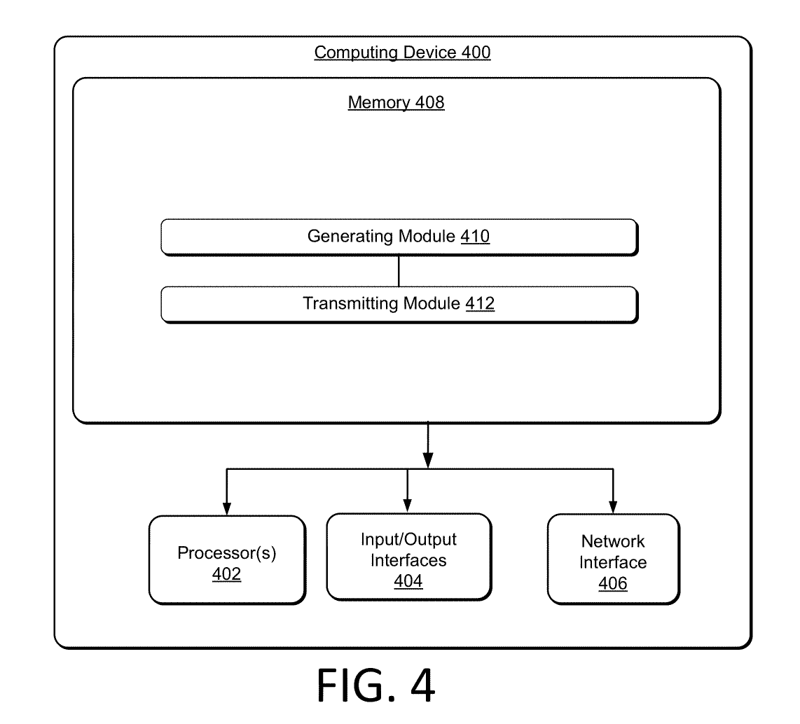

FIG. 4 is a schematic diagram of an illustrative computing device 400 that enables packet transmission. Since the apparatus of the implementations is substantially similar to the method implementations above, a relatively simple description follows referring to at least a part of the method implementations. The following description of the implementations are merely illustrative.

The device 400 may include one or more processors 402, input/output interfaces 404, network interface 406, and memory 408. The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include a generating module 410 and a transmitting module 412. The generating module 410 may be configured to generate a transmission packet corresponding to a specific packet associated with a first mobile terminal. The specific packet may include local data and/or remote data and the transmission packet may include the local data and/or a remote data identifier capable of retrieving the remote data from the specific packet. The transmitting module 412 may be configured to transmit the transmission packet to a second mobile terminal using short-range or near-field data transmission techniques. For instance, the specific packet may include an order packet, and data of the transmission packet includes at least one of an identifier of items related to a specific order, a title of the items, a specification of the items, or a number of the items.

In implementations, the transmitting module may include a generating submodule configured to generate a QR code of data of the transmission packet based on the transmission packet, and a scanning submodule configured to obtain the transmission packet in response to scanning of the QR code using an application of the second mobile terminal.

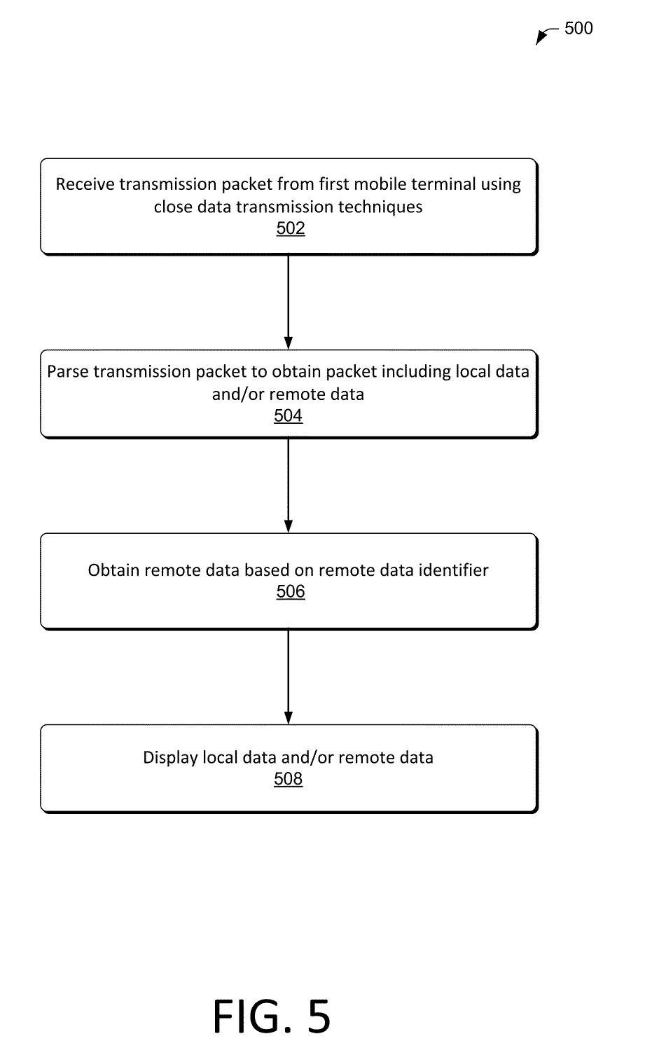

The implementations further relate to a method for receiving packet. Corresponding to the method for packet receiving, the implementations further relate to a device for receiving packet. FIG. 5 is a flow chart of an illustrative process 500 for receiving packets.

At 502, a computing device (e.g., a mobile device) may receive the transmission packet from a first mobile terminal using short-range or near-field data transmission techniques. The transmission packet may include the local data and/or a remote data identifier capable of retrieving the remote data of the specific packet. In implementations, the receiving the transmission packet from the first mobile terminal using the close data transmission techniques may include obtaining the transmission packet in response to scanning of the QR code from a display of the first mobile terminal.

At 504, the computing device may parse the transmission packet to obtain the specific packet including local data and/or remote data. In implementations, the parsing the transmission packet may include parsing the QR code. For example, the second mobile terminal may scan the QR code that is displayed on the screen of the first mobile terminal and then parse the transmission packet via a specific decoding application to obtain the specific packet including local data and/or remote data;

At 506, the computing device may obtain the remote data based on the remote data identifier. For example, the obtaining the remote data based on the remote data identifier may include transmitting a reading request to a server transmitting the remote data based on the remote data, and receiving the remote data from the server.

In implementations, the specific packet may include an order packet. The order packet may include local data and remote data related to the item of the specific order. The QR code may be generated by the first mobile terminal based on the identifiers of the items in the specific order.

After the second mobile terminal obtains the identifiers, the second mobile terminal may request for detailed item information corresponding to the identifiers. The detailed item information may include remote data of the specific order such as photos of the items.

At 508, the computing device may display the local data and/or the remote data.

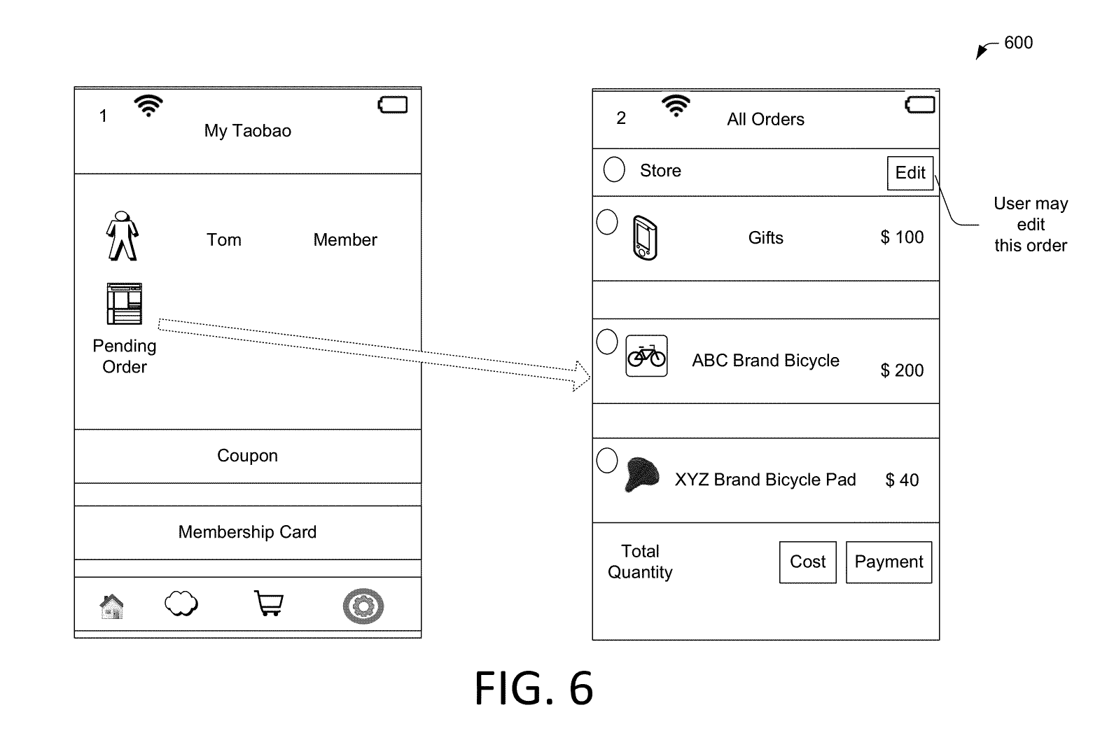

FIG. 6 is a schematic diagram of an illustrative sharing interface 600 for receiving packet associated with the second mobile terminal. In implementations, the second mobile terminal may scan the QR code that is displayed on the screen of the first mobile terminal, and parse the scanned QR code. The second mobile terminal may further display the order copy including all the items, specifications of the items, and/or quantity of the items.

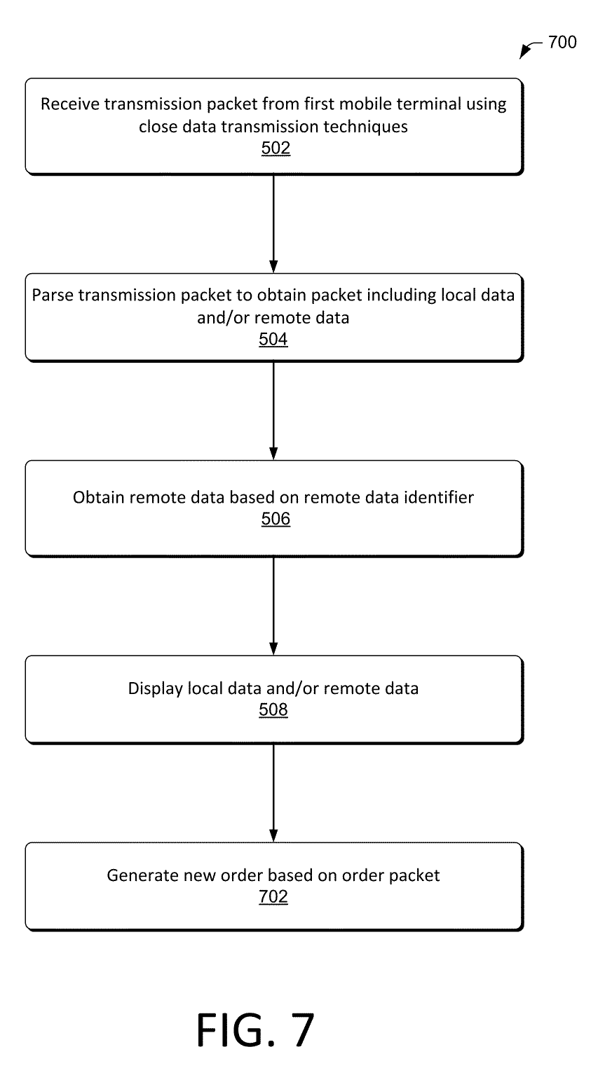

FIG. 7 is another flow chart of an illustrative process for receiving packets. In addition to the operations 502-508 that are discussed in FIG. 5, FIG. 7 may include the following operations related to receiving of packets. At 702, a computing device (e.g., a mobile device) may generate a new order based on the specific order.

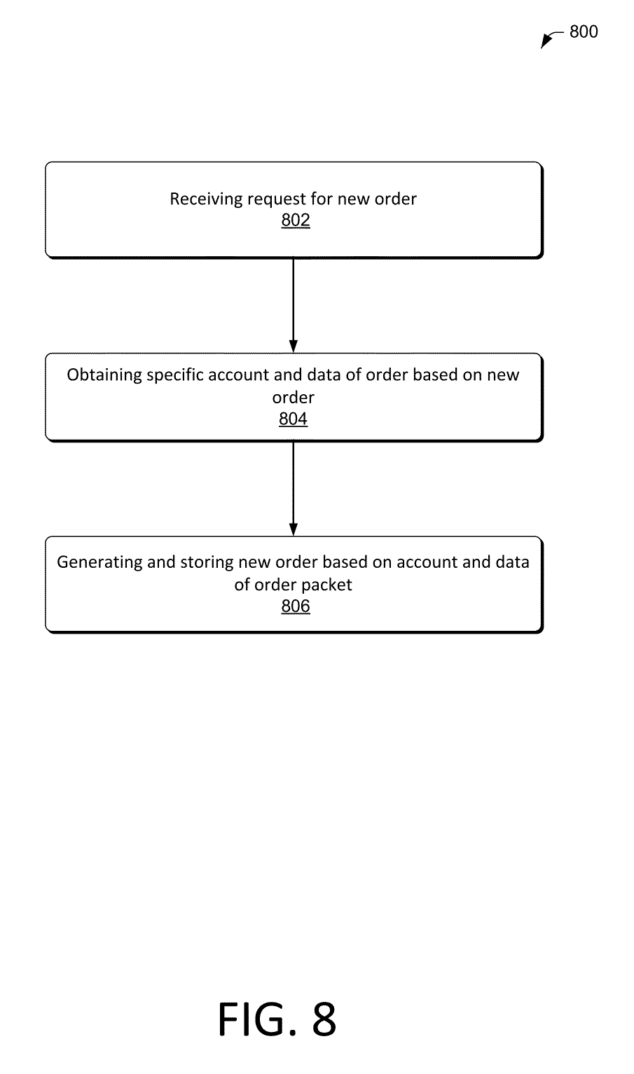

FIG. 8 is a flow chart of an illustrative process 800 for the operation 702 described in FIG. 7. The generating the new order based on the specific order may include receiving a request for the new order at 802, obtaining a specific account and data of the specific order based on the new order at 804, and generating and storing the new order based on the specific account and the data of the specific order at 806.

In implementations, before generating the new order based on the specific order, a user of the second mobile terminal may perform various operations on the order copy displayed on the second mobile terminal. The operations may include deleting one or more items or modifying specifications and/or quantities of the items. The user of the second mobile terminal may then submit the items of the obtained order copy or modified order copy to a server associated with an E-Commerce service provider (e.g., Taobao). A new order may be generated based on the user account of the user.

Suppose that user A has purchased items from Taobao and is satisfied with the quality. User A may recommend the items to user B using the following operations.

User A bought a bicycle assembly and related accessories from Taobao and an order is generated.

After taking a look, user B likes the bicycle and related accessories and currently needs a bicycle as well. User B may request that user A recommend the item.

User A opens Taobao app on the mobile device and finds his order in “My Order.” User A may further select “Clone Order.”

User B may activate “My Taobao.” When the mobile devices of user A and user B are close to each other, the order of user A may be copied and transmitted to Taobao of user B. Further, item information of the order may be displayed on the mobile device of user B.

User B may make changes on the item information and submit the copied and changed order to Taobao. User B may then makes the payment to finalize the order.

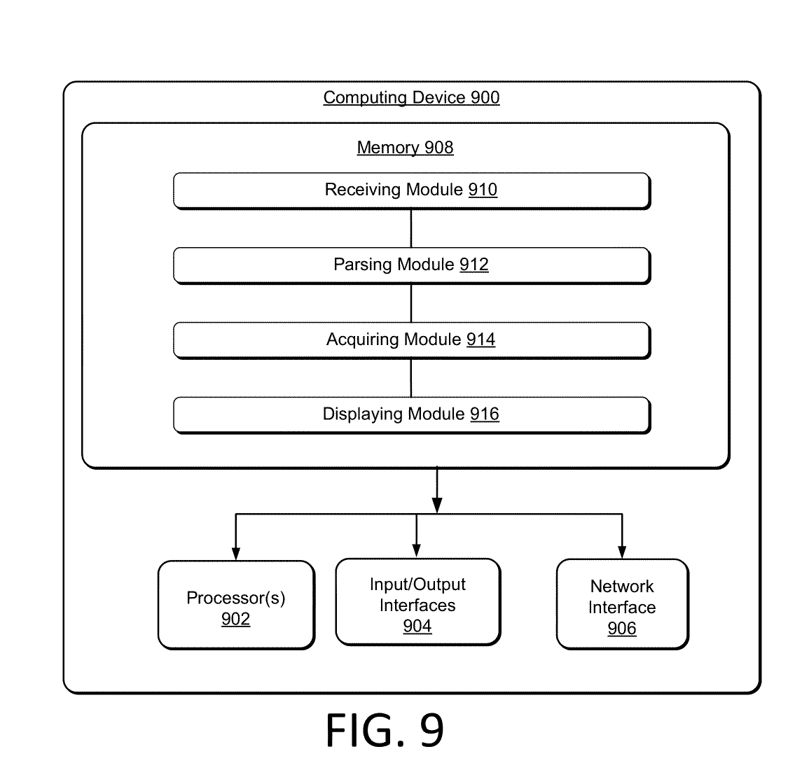

The implementations relate to a method for receiving packets. Corresponding to the method, the implementations further relate to a device for receiving packets. FIG. 9 is a schematic diagram of an illustrative computing device 900 that enables receiving packets. The device 900 may include one or more processors 902, input/output interfaces 904, network interface 906, and memory 908.

The memory 908 may include computer-readable media in the form of volatile memory, such as random-access memory (RAM) and/or non-volatile memory, such as read only memory (ROM) or flash RAM. The memory 908 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 908 in more detail, the memory 908 may include a receiving module 910, a parsing module 912, an acquiring module 914, and a displaying module 916. The receiving module 901 may be configured to receive the transmission packet from a first mobile terminal using close data transmission techniques. The transmission packet may include the local data and/or a remote data identifier capable of retrieving the remote data from the specific packet.

The parsing module 912 may be configured to parse the transmission packet to obtain the specific packet including local data and/or remote data. The acquiring module 914 may be configured to obtain the remote data based on the remote data identifier. The displaying module 916 may be configured to display the local data and/or the remote data.

In implementations, the receiving the transmission packet from the first mobile terminal using the close data transmission may include obtaining the transmission packet in response to scanning of the QR code from a display of the first mobile terminal. For instance, the parsing the transmission packet may include parsing the QR code.

In implementations, the acquiring module 914 may include a requesting module configured to transmit a reading request to a server transmitting the remote data based on the remote data identifier, and a receiving submodule configured to receive the remote data from the server. For instance, the specific packet includes an order packet.

In implementations, the memory 908 may further include a generating module configured to generating a new order based on the specific order. For instance, the generating module may include a receiving submodule configured to receive a request for the new order, an acquisition submodule configured to obtain a specific account and data of the specific order based on the new order, and a generating submodule configured to generate and store the new order based on the specific account and the data of the specific order.

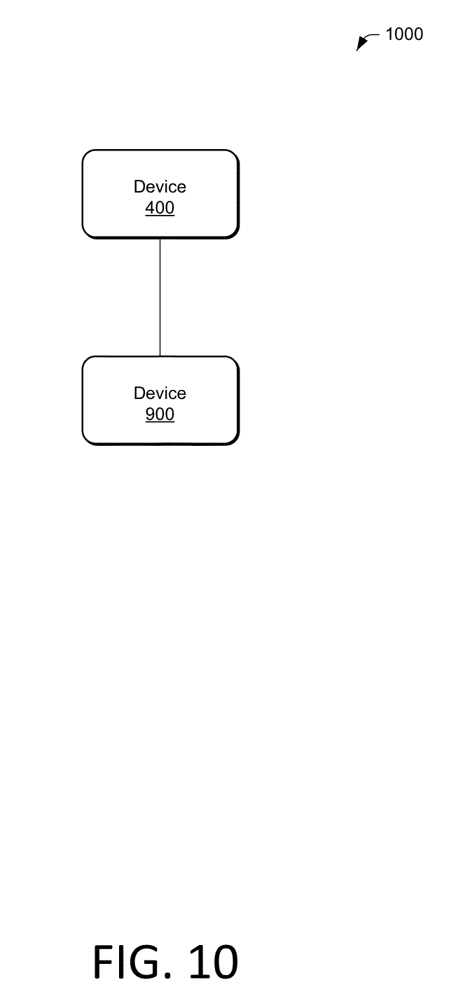

The implementations further relate to a system for packet transmission. FIG. 10 is a schematic diagram of an illustrative computing system 1000 that enables packet transmission.

The system 1000 may include the device 400 for packet transmission and the device 900 for receiving packets. The device 400 for packet transmission and the device 900 for receiving packets may be deployed in mobile communication devices, PC, PAD, iPad and other devices. For example, the device 400 for packet transmission may be deployed in mobile devices, which are able to transmit transmission packets. The device 900 for receiving packets may be deployed in mobile devices, which are able to receive packets. When the transmission packet includes a remote data identifier of the remote data in the specific packet, the system 1000 may further include a server for storing the remote data.

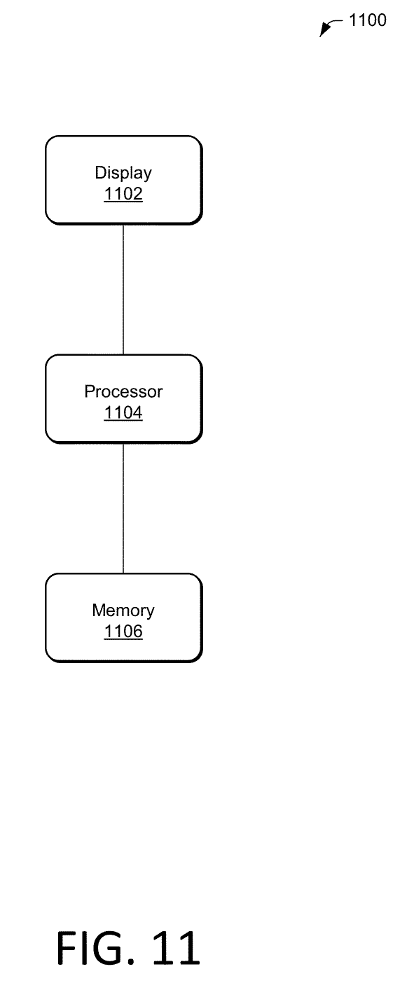

The implementations further relate to a mobile device. FIG. 11 is a schematic diagram of an illustrative mobile device 1100. The mobile device may include a display 1102, a processor 1104, and memory 1106. The processor 1004 may be configured to store a mobile shopping application. Upon implementing the mobile shopping application by the processor 1104, the mobile device 1100 may display a pending order interface associated with a first user account in the display 1102. For example, the pending order interface may include pending orders that are transferred in bulk from a mobile device associated with a second user account. The mobile device may operate transactions associated with the pending orders under the second user account before the pending orders are transferred in bulk.

In implementations, the pending orders associated with the first user account may be generated by the mobile device associated with the second user account. In these instances, the specific packet associated with the second account may include various pending orders. An order number of one or more pending orders may be used as an identifier of the remote data of the specific packet. Based on the specific packet, the mobile device associated with the second user account may generate the transmission packet. The transmission packet may include at least order numbers of pending orders. By using packet transmission between two mobile devices, the mobile device associated with the first user account may obtain multiple pending orders via a single operations on data. Thereby the implementations enhance convenience and accuracy of information sharing between mobile terminals.

In implementations, orders usually are completed after a previous order is completed and validated by acquaintances. Specially, target buyers may see the items purchased by the acquaintances. This improves confidence and desire to purchase items.

The implementations herein relate to methods, systems, and devices for receiving and/or transmitting packets. A computing device (e.g., a mobile device) may generate a transmission packet corresponding to a specific packet associated with a first mobile terminal, and transmit the transmission packet to a second mobile terminal using close data transmission techniques. The computing device may receive the transmission packet from a first mobile terminal using close data transmission techniques, parse the transmission packet to obtain the specific packet including local data and/or remote data, and obtain the remote data based on the identifier of the remote data, and display data of a specific packet associated with the first mobile terminal on a display associated with the second mobile terminal. The implementations thereby enhance convenience and accuracy of information sharing between mobile terminals.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method, comprising:
generating, by one or more processors of a computing device, a transmission packet corresponding to a packet associated with a first mobile terminal, the packet including local data or remote data, the transmission packet including the local data or a remote data identifier capable of retrieving the remote data of the packet; and
transmitting, by the one or more processors, the transmission packet to a second mobile terminal by near-field data transmission.

2. The method of claim 1, wherein the packet includes an order packet.

3. The method of claim 1, wherein data of the transmission packet includes at least one of an identifier of at least one item related to an order, a title of the at least one item, a specification of the at least one item, or a quantity of the at least one item.

4. The method of claim 1, wherein the transmitting the transmission packet to the second mobile terminal by the near-field data transmission comprises:
generating a matrix code of data of the transmission packet based on the transmission packet; and
enabling a transmission of the transmission packet to the second mobile terminal in response to the second mobile terminal scanning the matrix code.

5. The method of claim 1, wherein the near-field data transmission comprises at least one of Bluetooth, shake sharing or quick response code scanning.

6. The method of claim 1, wherein generating the transmission packet includes displaying the transmission packet on a display of the computing device to enable the second mobile terminal to scan the transmission packet using an application of the second mobile terminal.

7. One or more computer-readable media storing executable instructions that, when executed by a computing device, cause the computing device to perform acts comprising:
receiving a transmission packet from a first mobile terminal using near-field data transmission, the transmission packet including local data or a remote data identifier capable of retrieving remote data of a packet;
parsing the transmission packet to obtain the packet including the local data or the remote data;
obtaining the remote data based on the remote data identifier; and
enabling a display of the local data or the remote data on a display of the computing device.

8. The one or more computer-readable media of claim 7, wherein the receiving the transmission packet from the first mobile terminal by the near-field data transmission comprises obtaining the transmission packet in response to scanning of a matrix code from a display of the first mobile terminal.

9. The one or more computer-readable media of claim 8, wherein the parsing the transmission packet comprises parsing the matrix code.

10. The one or more computer-readable media of claim 7, wherein the obtaining the remote data based on the remote data identifier comprises:
transmitting a reading request to a server transmitting the remote data based on the remote data identifier; and
receiving the remote data from the server.

11. The one or more computer-readable media of claim 7, wherein the packet includes an order packet.

12. The one or more computer-readable media of claim 11, the acts further comprising:
generating a new order based on the order packet.

13. The one or more computer-readable media of claim 12, wherein the generating the new order based on the order packet comprises:
receiving a request for the new order;
obtaining an account and data of the order packet based on the new order; and
generating and storing the new order based on the account and the data of the order packet.

14. A device comprising:
one or more processors; and
memory to maintain a plurality of components executable by the one or more processors, the plurality of components comprising:
a receiving module configured to receive a transmission packet from a first mobile terminal by near-field data transmission, the transmission packet including local data or a remote data identifier capable of retrieving remote data of a packet;
a parsing module configured to parse the transmission packet to obtain the packet including the local data or the remote data,
an acquiring module configured to obtain the remote data based on the remote data identifier, and
a displaying module configured to display the local data or the remote data.

15. The device of claim 14, wherein the receiving module is further configured to obtain the transmission packet in response to scanning of a matrix code from a display of the first mobile terminal.

16. The device of claim 15, wherein the parsing module parses the transmission packet by parsing the matrix code.

17. The device of claim 14, wherein the acquiring module includes:
a requesting module configured to transmit a reading request for the remote data to a server based on the remote data identifier; and
a receiving submodule configured to receive the remote data from the server.

18. The device of claim 14, wherein the packet includes an order packet.

19. The device of claim 18, wherein the device further comprises:
a generating module configured to generate a new order based on the order packet.

20. The device of claim 19, wherein the generating module includes:
a receiving submodule configured to receive a request for the new order;
an acquiring submodule configured to obtain an account and data of the order packet based on the new order; and
a generating submodule configured to generate and store the new order based on the account and the data of the order packet.
